(19) United States
(12) Patent Application Publication
(10) Pub. No.: US 2026/0336978 A1
(43) Pub. Date: Oct. 29, 2026

(54) SYSTEMS, METHODS, AND APPARATUSES FOR SAFELY ENABLING, OPERATING, STORING, AND USING A REPOSITIONABLE LIFTING AND POSITIONING DEVICE

(71) Applicant: LEXIA SOLUTIONS, INC., Nashville, TN (US)

(72) Inventor: Jeffrey Runnels, Nashville, TN (US)

(21) Appl. No.: 19/657,301

(22) Filed: Apr. 24, 2026

Related U.S. Application Data
(60) Provisional application No. 63/794,449, filed on Apr. 25, 2025.

(51) Int. Cl. B66B 9/16; B66B 1/06

(52) U.S. Cl. CPC B66B 9/16; B66B 1/06

(57) ABSTRACT

A system, apparatus, and method for controlling operation of a repositionable lifting apparatus are disclosed. The apparatus includes a platform configured to support a user or mobility device and a lifting assembly configured to vertically move the platform relative to a support surface. A mobility system enables repositioning of the apparatus between locations. One or more sensor systems generate data associated with position, alignment, environmental conditions, or obstructions. A control system receives inputs from the sensor systems and one or more validation subsystems, evaluates the inputs using rule-based or conditional logic, and selectively enables or restricts operation of the apparatus. Operational functions, including lifting, deployment, and relocation, are permitted only when one or more validation conditions are satisfied. The system may further include validation subsystems for geographic location, alignment, and authorization, and may prevent operation when required conditions are not met.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

This application claims priority to U.S. Provisional Patent Application Serial No. 63/794,449 filed Apr. 25, 2025, the entirety of which is incorporated by reference herein.

### BACKGROUND

### 1. Field of the Invention

The present disclosure relates generally to a repositionable lifting and positioning device. More particularly, this disclosure pertains to systems, methods, and apparatuses for safely enabling, operating, and storing a repositionable lifting and positioning device.

### 2. Description of the Prior Art

Many issues surround the use of repositionable lifting and positioning devices by users, for example, wheelchair (or mobility device) users, for granting access to or overcoming “barriers of access.” Barriers of access may include raised seating or standing areas such as bars, elevated eating counters, high-top tables, casino tables, elevated workstations, standing areas at concerts, and raised business counters such as bank teller windows. Traditional raised seating or standing areas are not equipped with lifting systems to accommodate wheelchair users. As such, when wheelchair users frequent such locations, they are often disadvantaged because their eye level when seated is below the raised structure. Similarly, standing areas at concerts and events often do not provide accommodations that allow wheelchair users to achieve a comparable line of sight. In both social and business settings, these limitations can reduce accessibility, participation, and user experience.

In certain instances, barriers of access may also include stairs. A lifting and positioning device may be useful for overcoming stairs, either at a residence or in a commercial environment. In some cases, such devices may assist a business in achieving compliance with accessibility requirements, such as those set forth under the Americans with Disabilities Act (ADA), without requiring permanent structural modifications such as ramps.

The use of repositionable lifting devices presents additional challenges beyond those associated with permanently installed systems. Certain issues concern where the device can safely be used and whether the device is properly positioned relative to a barrier of access. Permanently installed lifting systems are typically anchored and calibrated at a fixed location, which helps ensure proper alignment, leveling, and safe operation. In contrast, repositionable devices are intended to be deployed at multiple locations, which introduces variability in positioning, surface conditions, and environmental factors.

Additional challenges include ensuring that the lifting platform is level during use, confirming that the device is properly aligned relative to the intended barrier of access, and preventing deployment in unsafe conditions. For example, improper positioning, insufficient clearance, uneven surfaces, or nearby obstructions may result in unsafe operation. Conventional repositionable devices generally rely on user judgment for placement and operation, which may not consistently ensure safe or optimal positioning.

Further issues arise with respect to deployment and operation of the device. For example, it may be difficult to determine whether a deployment area is free of obstructions prior to unfolding or extending the device. Similarly, conventional devices may lack mechanisms for verifying that the device is positioned within an acceptable operating environment or that required conditions for safe use have been satisfied before activation.

Still further challenges relate to mobility, storage, and power management. Repositionable devices must be transported between locations, potentially over uneven or inclined surfaces, and must be stored in a manner that protects against environmental exposure, vandalism, or theft. Charging and maintaining sufficient power for operation may also present logistical concerns, particularly in commercial environments.

Other issues with conventional lifting devices, particularly those intended for wheelchair users, include large size, bulkiness, and complex railing or structural systems that may limit usability in confined spaces such as bars, counters, or elevated platforms. Additionally, the footprint of such devices may occupy valuable space within commercial environments, potentially reducing their practicality and adoption. Many conventional systems also require semi-permanent installation, which limits flexibility and prevents efficient repositioning or storage when not in use.

### BRIEF SUMMARY

In view of at least some of the above-referenced problems associated with conventional lifting devices and accessibility systems, an exemplary object of the present disclosure may be to provide a repositionable lifting apparatus, system, and method configured to facilitate access to barriers of access while improving safety, mobility, and operational control. The present disclosure further provides systems and methods for controlling operation of such apparatus using sensor inputs, validation subsystems, and decision-based control logic to enable or restrict operation based on evaluated conditions.

In various embodiments, the present disclosure may provide a repositionable lifting apparatus configured to support a user or mobility device and to vertically position the user or mobility device relative to a support surface. The apparatus may further be configured for repositioning between locations and may incorporate one or more sensor systems, validation subsystems, and a control system configured to govern operation of the apparatus based on evaluated inputs.

In various embodiments, the present disclosure may further provide a control architecture including a decision engine configured to evaluate inputs from multiple subsystems, apply rule-based or conditional logic, and determine whether operation of one or more functions of the apparatus is permitted. The decision engine may prioritize safety-related inputs and may enable, restrict, or modify operation based on satisfaction of one or more validation conditions.

In a particular embodiment, an exemplary system for controlling operation of a repositionable lifting apparatus is provided. The system may include a platform configured to support a user or mobility device, a lifting assembly coupled to the platform and operable to vertically move the platform relative to a support surface, a mobility system configured to enable repositioning, one or more sensor systems configured to generate sensor data, and a control system including one or more processors and memory storing instructions that, when executed, cause the control system to receive sensor data and validation data, determine whether one or more operating criteria are satisfied based on the received data, and selectively enable, restrict, modify, or prevent operation of the apparatus based on the determination.

In an exemplary aspect according to the above-referenced embodiment, the instructions may further cause the control system to prioritize safety-related inputs over user inputs when determining whether to enable or restrict operation.

In another exemplary aspect according to the above-referenced embodiment, the instructions may further cause the control system to initiate a fail-safe response upon detection of a fault condition.

In another exemplary aspect according to the above-referenced embodiment, determining whether the operating criteria are satisfied may include evaluating a plurality of criteria in combination.

In another exemplary aspect according to the above-referenced embodiment, the control system may treat a user command as a request for operation and may conditionally execute the request only when the operating criteria are satisfied.

In another exemplary aspect according to the above-referenced embodiment, the validation data may include geographic data.

In another exemplary aspect according to the above-referenced embodiment, the geographic data may include geofencing data configured to restrict operation outside a permitted area.

In another exemplary aspect according to the above-referenced embodiment, the validation data may include positional alignment data.

In another exemplary aspect according to the above-referenced embodiment, the positional alignment data may be generated based on detection of one or more reference elements and corresponding sensors.

In another exemplary aspect according to the above-referenced embodiment, the validation data may include authorization data.

In another exemplary aspect according to the above-referenced embodiment, the authorization data may be received from an external device.

In another exemplary aspect according to the above-referenced embodiment, the one or more sensor systems may include at least one of optical, infrared, laser, ultrasonic, LiDAR, electromagnetic, and/or other sensors.

In another embodiment, a repositionable lifting apparatus is provided. The apparatus may include a platform movable between a collapsed configuration and a deployed configuration, a lifting mechanism operatively coupled to the platform and operable to cause vertical movement of the platform relative to a support surface, a mobility system configured to reposition the apparatus, one or more sensors configured to detect at least one of position, alignment, environmental conditions, obstructions, load, or system status, and a control system including one or more processors and memory storing instructions that, when executed, cause the control system to receive inputs from the one or more sensors and at least one validation subsystem, determine whether one or more operating criteria are satisfied, and selectively enable, restrict, modify, or prevent at least one of lifting, deployment, or relocation of the apparatus based on the determination.

In an exemplary aspect according to the above-referenced embodiment, the operating criteria may include validation of location, alignment, authorization, and safe operating conditions, including environmental conditions.

In another exemplary aspect according to the above-referenced embodiment, the control system may prevent operation when one or more of the operating criteria are not satisfied.

In another exemplary aspect according to the above-referenced embodiment, evaluation of the operating criteria may be performed sequentially, in parallel, asynchronously, or in a dynamically adjusted order.

In another exemplary aspect according to the above-referenced embodiment, the apparatus may further include a projection system configured to indicate a deployment area.

In another exemplary aspect according to the above-referenced embodiment, the control system may prevent deployment of the platform when the deployment area is obstructed.

In another embodiment, a method of operating a repositionable lifting apparatus is provided. The method may include receiving sensor data and validation data from one or more subsystems, evaluating the received data using a control system, determining whether one or more operating criteria are satisfied, and controlling operation of the apparatus by enabling at least one function when the operating criteria are satisfied and restricting, modifying, or preventing at least one function when the operating criteria are not satisfied.

In an exemplary aspect according to the above-referenced embodiment, the method may include selectively enabling or disabling individual operational functions based on the operating criteria, including prioritizing safety-related inputs over user inputs.

### BRIEF DESCRIPTION OF THE SEVERAL VIEWS OF THE DRAWINGS

FIG. 1 is a perspective view of an exemplary embodiment of a repositionable lifting apparatus in a non-collapsed (deployed) configuration in accordance with the present disclosure.

FIG. 2 is a perspective view of the repositionable lifting apparatus of FIG. 1 illustrating structural components of the platform, lifting mechanism, and support columns in accordance with the present disclosure.

FIG. 3 is a rear elevational view of the repositionable lifting apparatus in a collapsed configuration, illustrating compact storage and transport features in accordance with the present disclosure.

FIG. 4 is a perspective view of the repositionable lifting apparatus illustrating a footprint projection system for identifying a deployment area in accordance with the present disclosure.

FIG. 5 is a perspective view of an alternative embodiment of the repositionable lifting apparatus including dual support columns in accordance with the present disclosure.

FIG. 6 is a top plan view of the repositionable lifting apparatus illustrating a safety envelope and sensor coverage area in accordance with the present disclosure.

FIG. 7 is a perspective view illustrating a sensor system including scanning sensors and a light curtain system associated with the repositionable lifting apparatus in accordance with the present disclosure.

FIG. 8 is a side elevational view illustrating operation of sensors and ramp positioning of the repositionable lifting apparatus in accordance with the present disclosure.

FIG. 9 is a perspective view of the repositionable lifting apparatus in a deployed configuration illustrating platform and ramp features in accordance with the present disclosure.

FIG. 10 is a perspective view illustrating interaction between the repositionable lifting apparatus and reference elements positioned at a barrier of access in accordance with the present disclosure.

FIG. 11 is a front view of a user interface or control panel for operating the repositionable lifting apparatus in accordance with the present disclosure.

FIG. 12 is a perspective view of an embodiment of a repositionable lifting apparatus with a single lifting column in accordance with the present disclosure.

FIG. 13 is a schematic diagram illustrating a validation system including geographic validation, alignment validation, and authorization input in accordance with the present disclosure.

FIG. 14 is a schematic diagram illustrating a control system architecture including sensor inputs, validation subsystems, and a decision engine in accordance with the present disclosure.

FIG. 15 is a schematic diagram illustrating autonomous or semi-autonomous relocation of the repositionable lifting apparatus within a defined operational area in accordance with the present disclosure.

FIG. 16 is a schematic diagram illustrating a deployment validation sequence of the repositionable lifting apparatus in accordance with the present disclosure.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

The words “connected”, “attached”, “joined”, “mounted”, “fastened”, and the like should be interpreted to mean any manner of joining two objects including, but not limited to, the use of any fasteners such as screws, nuts and bolts, bolts, pin and clevis, and the like allowing for a stationary, translatable, or pivotable relationship; welding of any kind such as traditional MIG welding, TIG welding, friction welding, brazing, soldering, ultrasonic welding, torch welding, inductive welding, and the like; using any resin, glue, epoxy, and the like; being integrally formed as a single part together; any mechanical fit such as a friction fit, interference fit, slidable fit, rotatable fit, pivotable fit, and the like; any combination thereof; and the like.

Unless specifically stated otherwise, any part of the apparatus of the present disclosure may be made of any appropriate or suitable material including, but not limited to, metal, alloy, polymer, polymer mixture, wood, composite, or any combination thereof.

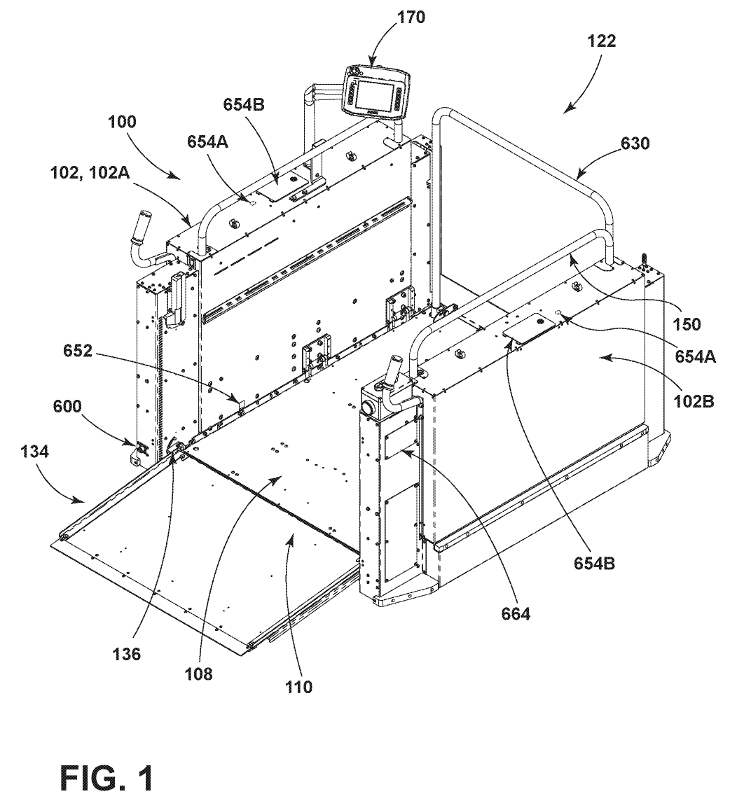

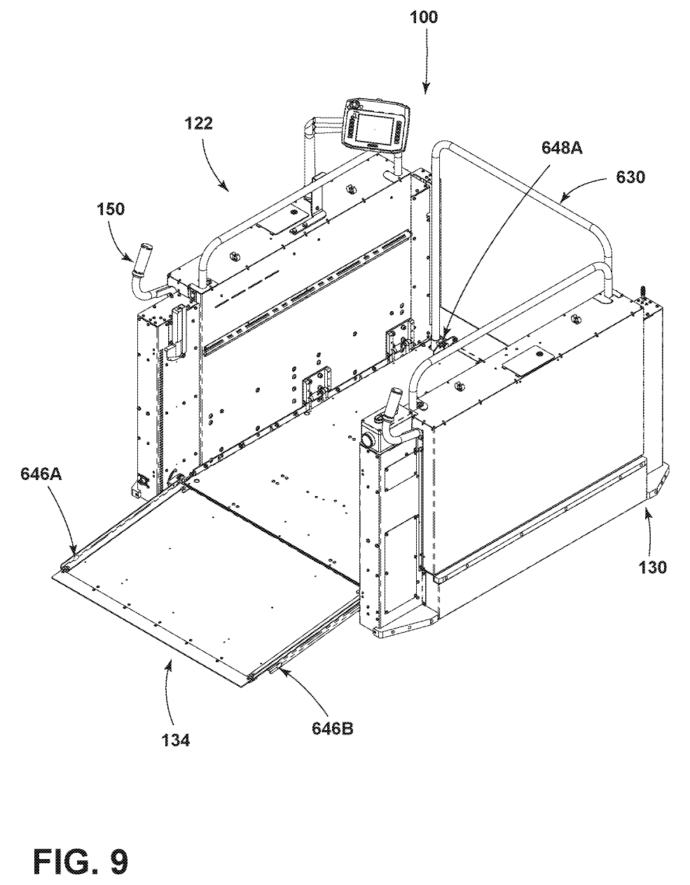

Referring to FIGS. 1-10 and 12, exemplary embodiments of a repositionable lifting apparatus 100 for lifting and positioning a mobility device, such as, for example, a wheelchair, and the user thereof according to aspects of the present disclosure are illustrated. The repositionable lifting apparatus 100 may also be referred to herein as a repositionable lifting device 100, a lifting device 100, and/or a device 100.

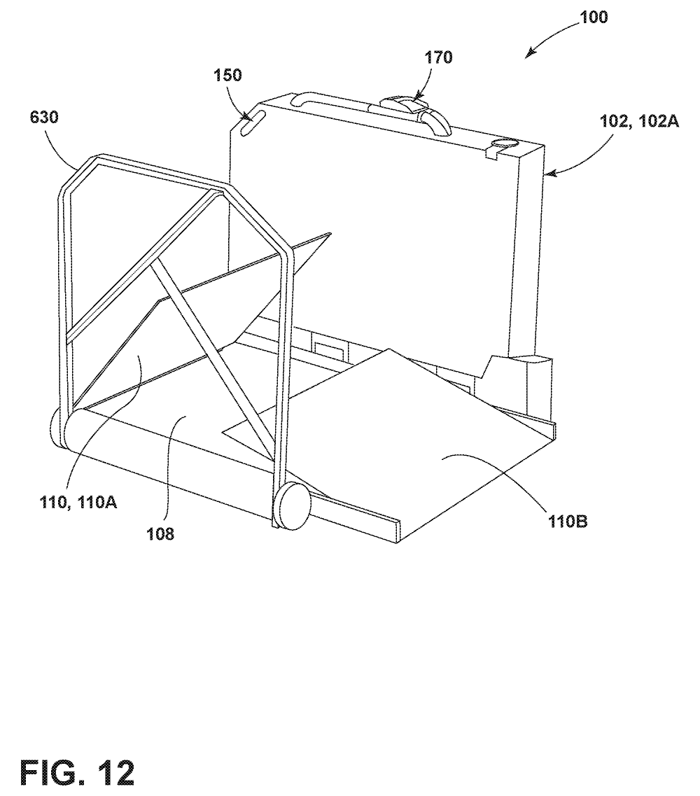

The repositionable lifting apparatus 100 may include at least one lifting column 102, a lifting mechanism 104, a platform support assembly 106, a platform 108, and/or at least one ramp 110. The lifting column 102 may also be referred to herein as a support structure 102. As illustrated in FIG. 12, the repositionable lifting apparatus 100 in various embodiments might include only a single lifting column 102A, although use of only a single lifting column 102 is not required by the present disclosure. The single lifting column 102A may also be referred to herein as a first lifting column 102A. As illustrated in FIGS. 1-10, the repositionable lifting apparatus 100 may include two or more lifting columns, for example, a first lifting column 102A and a second lifting column 102B. As used herein, the phrase “configured to” may refer to structural components, programmed processors, control circuitry, or combinations thereof that enable performance of the recited functionality.

In certain embodiments, components described as being “configured to” perform a function may include one or more structural elements, actuators, mechanical linkages, sensors, processors, or control circuitry that enable performance of the recited function. Such configurations may be achieved through hardware, software, firmware, or combinations thereof, and may include equivalent structural arrangements capable of performing the described functionality.

In certain embodiments, the apparatus may include one or more limit switches associated with structural components including ramps, front support structures, and platform elements. The control system may be configured to prevent operation of the apparatus unless the limit switches confirm that the apparatus is properly configured for use.

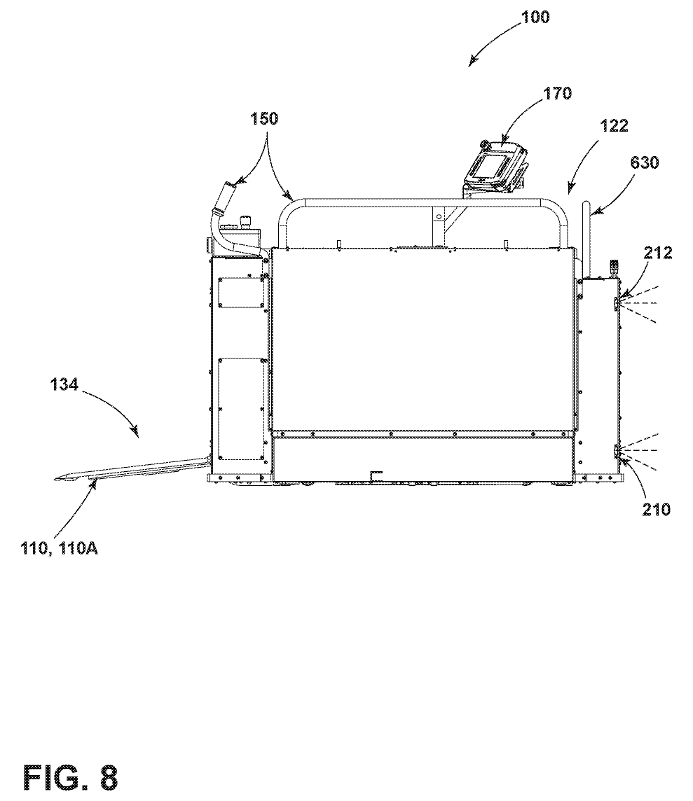

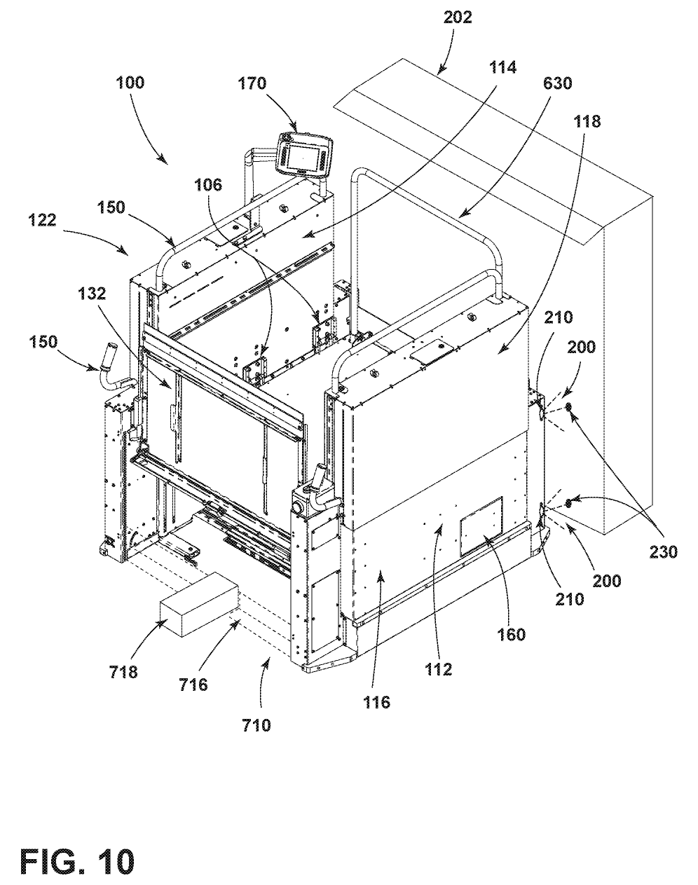

In certain embodiments, as illustrated in FIGS. 8 and 10, the apparatus may include a collapsible railing 630 configured to provide user support during entry, exit, and operation of the apparatus. The collapsible railing 630 may be positioned along a front edge 128A of the platform 108. The collapsible railing 630 may be adjustable, foldable, or removable and may be configured to serve as a structural safety component and/or a storage interface. The control system may restrict operation unless the collapsible railing 630 is properly positioned. As illustrated in FIG. 12, the collapsible railing 630 may be positioned along a side edge of the platform 108.

In certain optional embodiments, the first and second lifting columns 102A, 102B may be structural mirror images of one another. In other optional embodiments, the first and second lifting columns 102A, 102B may differ, namely, by including one or more additional or fewer components. For simplicity, a single lifting column 102 will now be described in terms of common elements which may be shared by the first and second lifting columns 102A, 102B.

In certain embodiments, the apparatus may include a rear lift gate configured to facilitate entry and exit of a user onto the platform. The rear lift gate may be removable, foldable, or otherwise reconfigurable, and may be integrated with the control system to ensure safe operation.

In certain embodiments, the apparatus may include one or more exit features configured to facilitate safe and controlled departure of a user from the platform, including ramp deployment, gate operation, or guided descent sequences controlled by the control system.

Each of the at least one lifting column 102 of the repositionable lifting apparatus 100 may have a lower portion 112 that is supportable upon a support surface and an upper portion 114 coupled to the lower portion 112 and which may move vertically relative to the lower portion 112. The at least one lifting column 102 has a length, a width, and an adjustable height based on the movement of the upper portion 114 relative to the lower portion 112. The at least one lifting column 102 may structurally be formed of materials providing sufficient strength such as steel, aluminum, fiberglass composite, graphite composite, or any other material as known in the art. The at least one lifting column 102 may optionally include one or more materials and/or additional structures intended to provide sufficient strength, desired deflection characteristics, corrosion resistance, or other properties of interest.

As illustrated by FIG. 10, the repositionable lifting apparatus 100 includes a lower covering 116 configured to cover at least the lower portion 112 of the at least one lifting column 102 and an upper covering 118 configured to cover at least the upper portion 114 of the at least one lifting column 102. The lower covering 116 may be coupled to the lower portion 112 of the at least one lifting column 102. Likewise, the upper covering 118 may be coupled to the upper portion 114 of the at least one lifting column 102 and may be configured to move in unison with the upper portion 114.

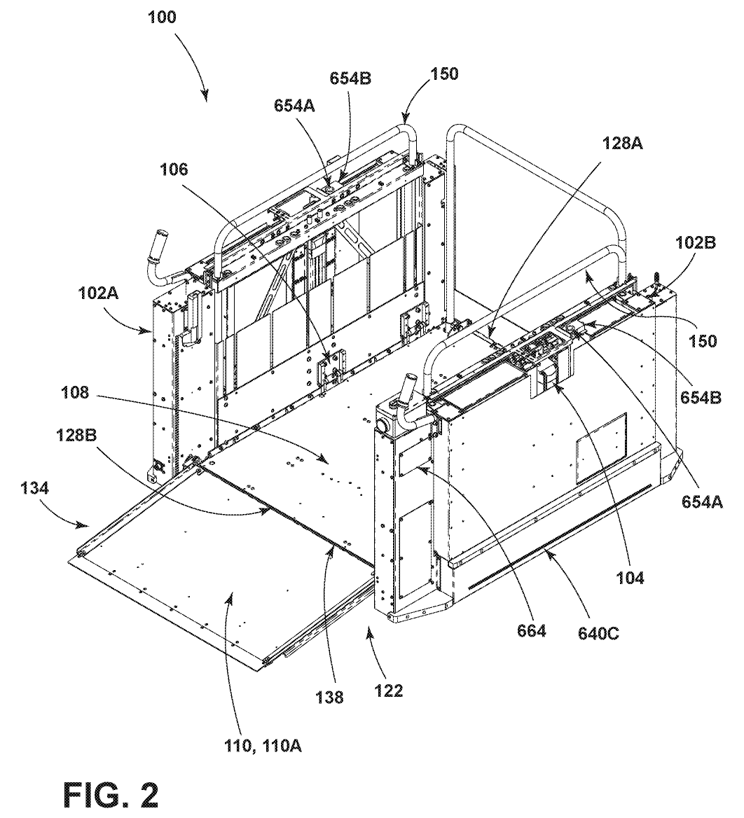

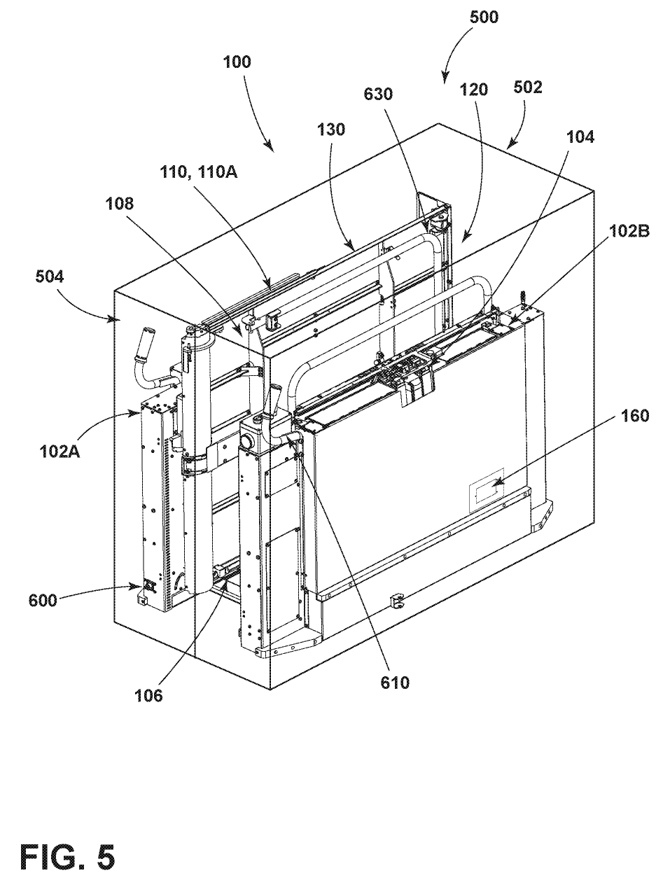

The lifting mechanism 104 may be coupled to the at least one lifting column 102. In the exemplary embodiments illustrated by FIGS. 2 and 5, the at least one lifting mechanism 104 may be housed within each at least one lifting column 102 and may be positioned parallel with the height of the lifting column 102. In certain embodiments, a position and/or arrangement of the lifting mechanism 104 may vary. Each lifting mechanism 104 may include a lower end and an upper end. The lower end of the lifting mechanism 104 may be coupled to the lower portion 112 of the lifting column 102. The upper end of the lifting mechanism 104 may be coupled to the upper portion 114 of the lifting column 102. The lifting mechanism 104 is configured to move the upper portion 114 of the lifting column 102 relative to the lower portion 112, in a vertical direction. The lifting mechanism 104 may be any type of lift device configured to enable a movement between the upper and lower portions 114, 112 of the lifting column 102. For example, the lifting mechanism 104 may be a scissor lift, a rigid chain actuator, a traveling nut actuator, a hydraulic actuator, an electro-mechanical actuator, an electric linear actuator, or any other means of conveyance. The lifting mechanism 104 may be powered electrically, however in certain other optional embodiments, it may be powered mechanically, hydraulically, or by any other power source capable of use. In certain embodiments, the lifting mechanism 104 comprises a linear force-transmitting assembly extending between the lower portion 112 and the upper portion 114, the assembly including at least one actuator body and at least one force transmission element selected from a screw drive, chain, linkage, piston, or equivalent structure configured to translate actuation into vertical displacement of the upper portion 114 relative to the lower portion 112

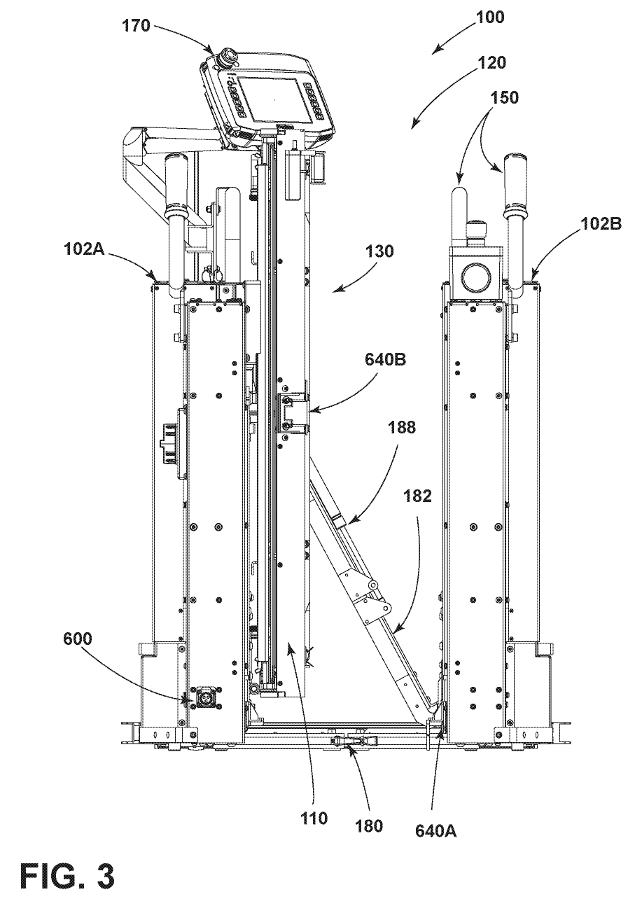

The platform support assembly 106 is attachable to each lifting mechanism 104. As seen in FIGS. 2 and 5, the platform support assembly 106 may be coupleable to at least one of a lower portion of the lifting mechanism 104 or the upper portion 114 of the at least one lifting column 102. The platform support assembly 106 may be operatively configured to move the platform 108 vertically in unison with the upper portion 114 of the at least one lifting column 102 as caused by movement of the lifting mechanism 104. The platform support assembly 106 may be operatively configured to pivot the platform 108 from a collapsed (stored/angled) configuration 120 (shown by FIGS. 3-5) to a non-collapsed (expanded/horizontal) configuration 122 (shown by FIGS. 1-2, 6-10, and 12) using either the lifting mechanism 104 or a platform actuator (not shown). The lifting mechanism 104 may be operatively coupled to the platform support assembly 106 to move the platform 108 from the collapsed configuration 120 to the non-collapsed configuration 122 prior to lifting the platform 108 when actuating in a direction associated with lifting the platform. The platform support assembly 106 may include a hinge that causes the bottom several inches of travel of the lifting mechanism 104 to fold and unfold the platform 108. For example, if the lifting mechanism’s 104 total travel is 20 inches, then from 0 to 4 inches of travel the platform 108 will fold or unfold, and from 4 to 20 inches of travel will lift the platform 108. In certain embodiments, the platform support assembly 106 comprises a rigid support frame including one or more arms, brackets, or linkage members extending between the lifting mechanism 104 and the platform 108, the rigid support frame being configured to both support the platform 108 and transmit forces from the lifting mechanism 104 to the platform 108. In certain embodiments, the collapsed configuration 120 corresponds to an orientation in which the platform 108 is positioned at a non-horizontal angle relative to the support surface and occupies a reduced footprint, and the non-collapsed configuration 122 corresponds to an orientation in which the platform 108 is substantially horizontal relative to the support surface and positioned for supporting a mobility device, wherein the transition between the configurations is defined by movement through a predetermined angular range of the platform 108 relative to the lifting column 102.

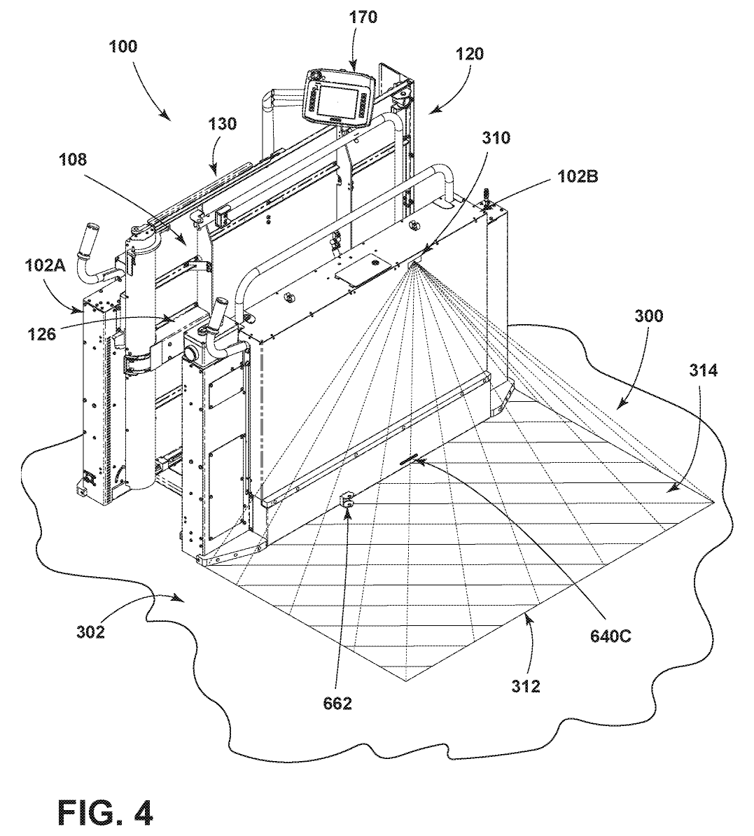

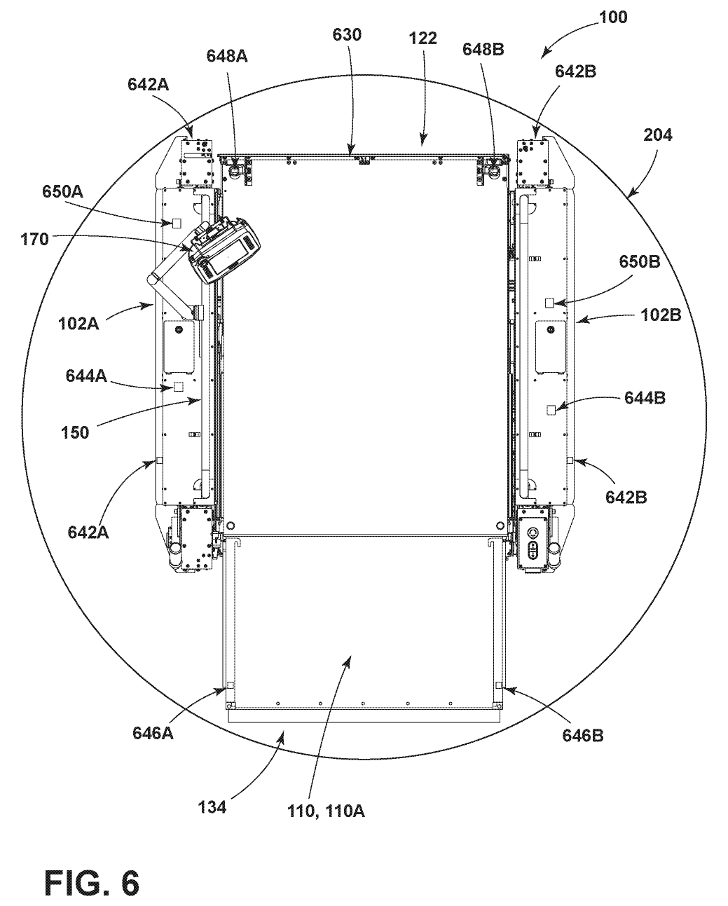

The platform 108 may include first and second side edges, one or more of which may be positioned adjacent to the at least one lifting column 102. In certain embodiments, the platform 108 comprises a substantially planar support surface defined by a rigid or semi-rigid panel structure having a thickness, a load-bearing upper surface, and an underside coupled to the platform support assembly 106, wherein the platform 108 defines a footprint sized to receive a mobility device. The platform 108 is configured to receive a mobility device and is further configured to position the mobility device above the support surface with the mobility device positioned thereon for granting access to elevated surfaces and/or to provide a better line of sight for a user of the mobility device. The platform 108 may further include a lateral actuator 126, shown by FIG. 4, which may be configured to move the platform 108 laterally in a direction parallel to the length of the at least one lifting column 102 to enable for better positioning of the user relative to an elevated surface or the like. As illustrated in FIG. 6, the at least one ramp 110 may comprise a rearward ramp 110A. In certain optional embodiments, the repositionable lifting apparatus 100 may include both a rearward ramp 110A and a forward ramp 110B.

The at least one ramp 110 may be coupled to the platform 108 along at least one of a front edge 128A or rear edge 128B thereof. The front and rear edges 128A, 128B may be defined between the first and second side edges. The at least one ramp 110 may be pivotally connected to the platform 108 and configured to pivot around the pivotal connection 138. The at least one ramp 110 may be configured to maintain its orientation relative to the platform 108. In various embodiments, the ramp 110 may selectively maintain its position in a first position 130 flat on top of the platform 108, for example when the platform 108 is in the collapsed configuration 120. Furthermore, the ramp 110 may selectively maintain its position in a second position 132 and/or a third position 134, both associated with the platform 108 being in the non-collapsed configuration 122. The second position 132 may orient the ramp 110 perpendicular to the platform 108 so that the mobility device when positioned on the platform 108 is prevented from rolling off, which is especially important when the platform 108 is lifted relative to the support surface. The third position 134 may orient the ramp 110 away from the platform 108 such that a distal portion of the ramp 110 is positioned on a support surface for granting access to the platform 108 by the mobility device. The ramp 110 may move between the first, second, and/or third positions 130, 132, 134 manually, or more preferably using a ramp actuator 136, shown in FIG. 1.

The repositionable lifting apparatuses 100 may further include a plurality of wheels coupleable to the lower portion 112 of each at least one lifting column 102. The plurality of wheels may be configured to be positioned in one of an extended configuration and/or a retracted configuration. The extended configuration may be useful for enabling movement of the repositionable lifting apparatus 100 (e.g., by elevating the lower portion 112 of the at least one lifting column 102 above the support surface), while the retracted configuration may be useful for ensuring that the repositionable lifting apparatus 100 does not move during use (e.g., that the lower portion 112 of the at least one lifting column 102 rests on the support surface). Accordingly, the extended configuration may be associated with the platform 108 of the repositionable lifting apparatus 100 being configured in the collapsed configuration 120. Likewise, the retracted configuration may be associated with the platform 108 being configured in the non-collapsed configuration 122. Each of the plurality of wheels may be permitted to move between the extended and retracted configurations using a wheel actuator. Each of the plurality of wheels may move relative to a ground surface using a wheel motor to assist rotation of each of the plurality of wheels. For example, the wheel motor may be an electric motor positioned within the wheel.

As illustrated in FIGS. 1-3, the repositionable lifting apparatuses 100 may further include at least one handle 150 either extending from each of the at least one lifting column 102 or defined in the upper covering 118 of the at least one lifting column 102. The at least one handle 150 may provide a grab point to aid in repositioning the repositionable lifting apparatus 100.

As illustrated, for example, by FIG. 5, the repositionable lifting apparatuses 100 may further include a battery bank 160 positioned within the at least one lifting column 102. The battery bank 160 may house at least one battery and may further be configured to power at least one component of the lifting mechanism 104 as well as to optionally electrically power one or more other components (e.g., the lifting mechanism 104, the lateral actuator 126, the ramp actuator 136, the wheel actuators, the wheel motors, etc.) of the repositionable lifting apparatus 100.

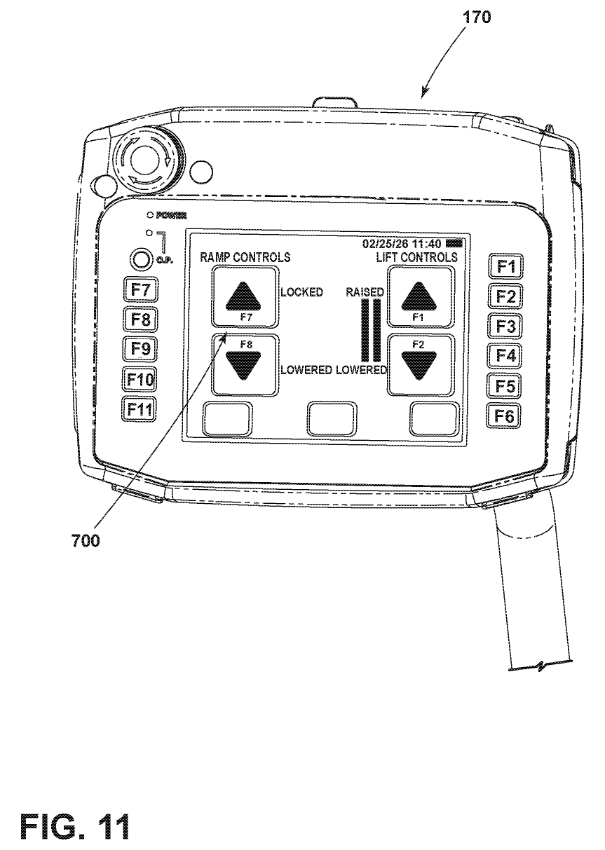

As further illustrated by FIGS. 1, 3, 8, and 11, the repositionable lifting apparatus 100 may include a controller 170 configured to be powered by at least the battery bank 160. The controller may also be referred to herein as a control system 170. In certain embodiments, the controller 170 comprises at least one processor and a memory storing executable instructions configured to control operation of the apparatus 100. The controller 170 may be configured to receive information from and to control one or more of the various actuators, sensor, and systems of the repositionable lifting apparatus 100. For example, movements of each of the lifting mechanism 104, the lateral actuator 126, the ramp actuator 136, the wheel actuators, the wheel motors, or the like may be controlled by the controller 170. The controller may also include a user interface 700 which may be interacted with by a user to control various aspects of the repositionable lifting apparatus 100, such as, for example, ramp position, lift height, or the like.

The repositionable lifting apparatus 100, when having only one lifting column 102A, may include first and second outriggers configured to pivot from a folded position (e.g., stored within a footprint of the lifting column), to an unfolded position. When in the unfolded position, the first and second outriggers are configured to rest upon the support surface for stabilizing the lifting column when the platform 108 is positioned in the non-collapsed configuration 122, lifting upward, and sliding forward. The first and second outriggers may be moved between the folded and unfolded positions using at least one outrigger actuator. The outrigger actuator may be communicatively linked to and controlled by the controller 170 for moving the first and second outriggers between the folded and unfolded positions.

Referring to FIG. 10, the repositionable lifting apparatus 100 may further include reference elements, tags, markers, or other position-identifying systems 200 configured to enable and disable certain functionalities of the repositionable lifting apparatus 100. The reference elements may include tags, markers, visual indicators, electronic beacons, or any system capable of identifying a designated position of use. In particular, the platform 108 may be configured such as not to move from a collapsed configuration 120 to a non-collapsed configuration 122 until the reference elements, tags, markers, or other position-identifying systems 200 enables said functionality.

The reference elements, tags, markers, or other position-identifying systems 200 may include a plurality of scanning sensors 210 coupled to the at least one lifting column 102 and a plurality of tags 230 positioned at various designated places of use 204 associated with barriers of access 202 for which a mobility device may need to overcome. In certain optional embodiments, the reference elements, tags, markers, or other position-identifying systems 200 may only include a single scanning sensor 210 and/or a single tag 230. The control system may prevent deployment unless proper alignment between the sensor system and the reference element is confirmed.

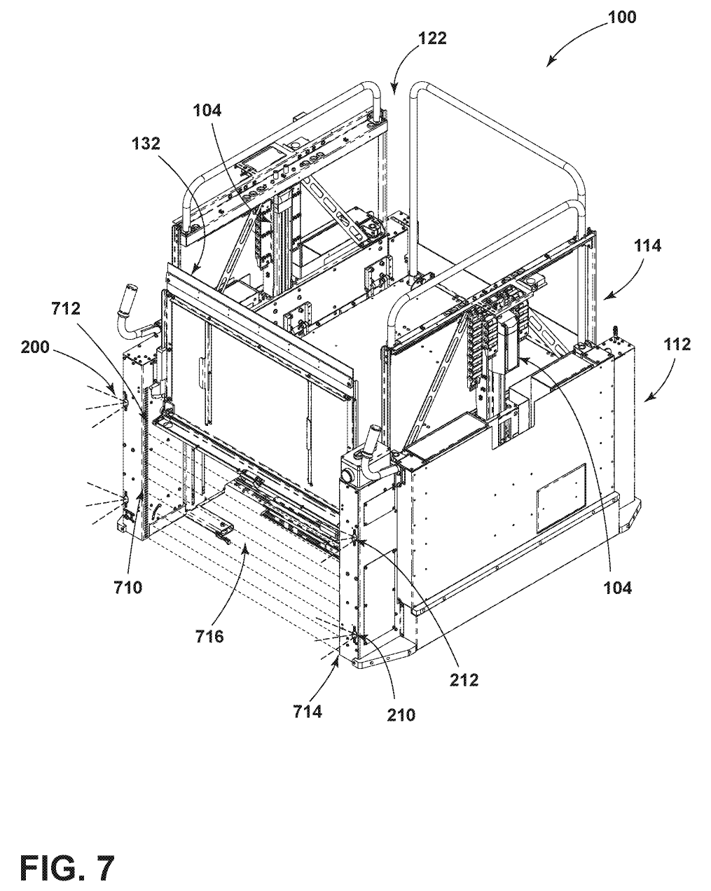

As illustrated by FIG. 7, the at least one lifting column 102 may include a at least one slot 212. Each of the at least one slot 212 configured to receive one of the plurality of scanning sensors 210. The at least one slot 212 may be provided at a front side of the upper covering 118, however, in other embodiments the at least one slot 212 may additionally or alternatively be defined on the sides and/or rear of the upper covering 118. In certain optional embodiments, the at least one slot 212 may be located on the lower covering 116 of the at least one lifting column 102.

The one or more sensors may be arranged in any configuration sufficient to detect position, orientation, proximity, or reference elements associated with a designated position of use, without limitation to a particular mounting configuration or scanning range.

Referring to FIG. 4, the repositionable lifting apparatus 100 may further include a footprint projection system 300. The footprint projection system 300 is configured to highlight and/or project onto a floor surface 302 (also referred to herein as a ground surface or a support surface) adjacent to the repositionable lifting apparatus 100 an outline of where the repositionable lifting apparatus 100 will be situated once the platform 108 is moved from the collapsed configuration 120 to the non-collapsed configuration 122. The footprint projection system 300 includes at least one projector 310 configured to project light in the form of a laser or some other visible light as an outline or fully shaded area of where the repositionable lifting apparatus 100 will be situated on the floor once the platform 108 is moved from the collapsed to the non-collapsed configuration 122. By projecting the footprint 312 onto the floor surface 302, the footprint projection system 300 allows the user to ensure that no objects are within the footprint 312 of the repositionable lifting apparatus 100 prior to initiating the unfolding sequence of the repositionable lifting apparatus 100.

In embodiments where the repositionable lifting apparatus 100 includes only one lifting column 102, the projector 310 of the footprint projection system 300 may be mounted to a bottom of the platform 108 such that the projector 310 may project onto the floor surface 302 an outline of where the platform 108 will be located once reconfigured from the collapsed to the non-collapsed configuration 122. Alternatively, projector 310 may be located on at least one lifting column 102, for example, on the upper covering 118 or some other suitable location such that the laser may be unobstructed when projecting onto the floor surface 302.

In certain embodiments, the term “operational conditions” may include one or more conditions associated with safe and permissible operation of the apparatus 100, including environmental conditions, structural conditions, system conditions, and/or user-related conditions. Environmental conditions may include, for example, weather-related factors such as precipitation, temperature, wind, or surface moisture. Accordingly, environmental conditions may be considered a subset of operational conditions, although the present disclosure is not limited to such a relationship.

In embodiments where the repositionable lifting apparatus 100 includes both the first and second lifting columns 102A, 102B, the projector 310 may be coupled to at least one of the first and second lifting columns 102A, 102B, for example coupled to the upper covering 118 of the column which may move to transition the platform 108 from the collapsed configuration 120 to the non-collapsed configuration 122. The projector 310 from the footprint projection system 300 may include a first projector coupled to a side of the first lifting column 102A and may include a second projector coupled to a side of the second lifting column 102B such that the repositionable lifting apparatus 100 may open in either direction (e.g., the first lifting column 102A may move relative to the second lifting column 102B or the second lifting column 102B may move relative to the first lifting column 102A). In accordance with this embodiment, the projector 310 associated with the direction that the repositionable lifting apparatus 100 may unfold and may project the outline of the repositionable lifting apparatus 100 prior to the platform 108 being transitioned into the non-collapsed configuration 122.

The footprint projection system 300 may function in conjunction with the reference elements, tags, markers, or other position-identifying systems 200 via the controller 170. In other words, the footprint projection system 300 may be selectively disabled until the repositionable lifting apparatus 100 has been properly aligned with at least one predetermined or dynamically determined tag of the plurality of tags 230 based at least in part upon one or more signals associated with the plurality of scanning sensors 210. Upon proper positioning of the repositionable lifting apparatus 100 relative to a tag, the footprint projection system 300 may automatically enable the projector 310 to project a footprint 312 of the repositionable lifting apparatus 100 onto the floor system prior to unfolding the repositionable lifting apparatus 100. In other optional embodiments, the projector 310 may additionally or alternatively be enabled manually.

In certain embodiments, the footprint projection system 300 may define an obstruction detection zone 314 corresponding to the projected footprint 312. The control system 170 may prevent deployment unless the obstruction detection zone 314 is determined to be unobstructed. The projected deployment area may correspond to a predicted movement envelope of the platform 108 during deployment and may be used to determine whether sufficient clearance exists prior to and during operation.

In certain embodiments, the repositionable lifting apparatus 100 may include an integrated control architecture configured to govern operation of the apparatus based on a multi-layer validation framework. The control architecture may include a control system 170 (which may also be referred to herein as a controller, control module, or processing system) configured to receive inputs, evaluate operating conditions, and selectively enable, restrict, or modify operation of one or more components of the apparatus 100.

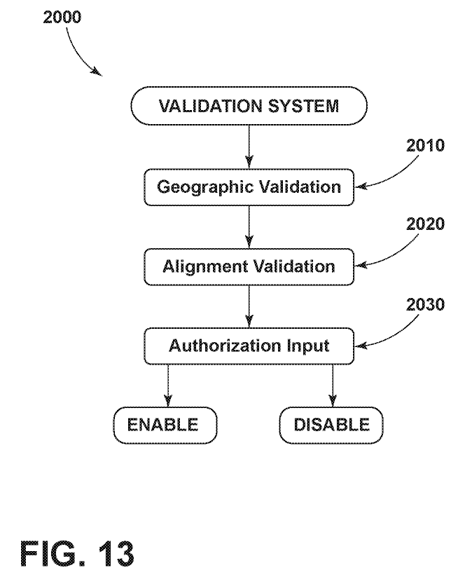

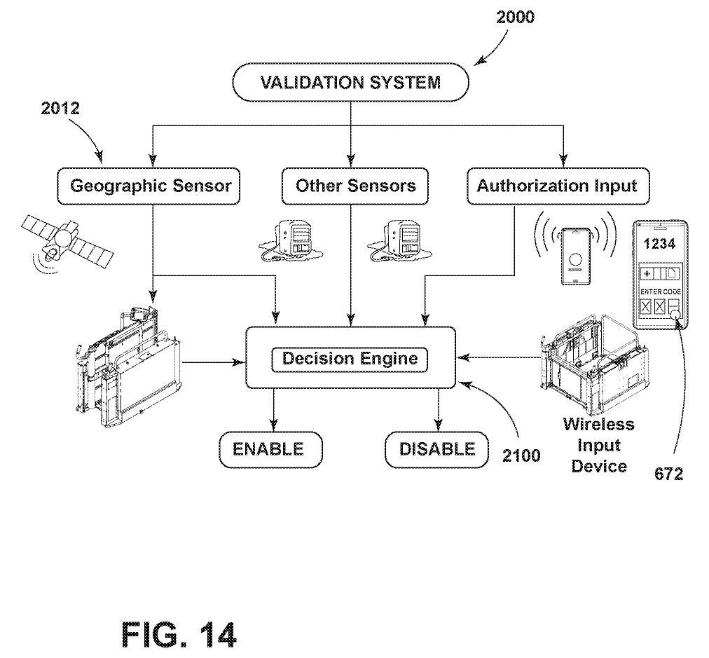

As illustrated in FIGS. 13 and 14, the control system 170 may include or be communicatively coupled to a validation system 2000 configured to determine whether operation of the apparatus 100 is permitted. The validation system 2000 may include one or more validation subsystems including, but not limited to:
(i) a geographic validation subsystem 2010;
(ii) a physical alignment validation subsystem 2020; and
(iii) an authorization validation subsystem 2030.

The geographic validation subsystem 2010 may be configured to determine whether the apparatus 100 is positioned within a permitted area of operation. Such determination may be based on one or more location detection technologies (i.e., geographic sensors 2012) including, for example, GPS signals, wireless network triangulation, beacon-based systems, short-range communication protocols, or combinations thereof. In certain embodiments, operation of the apparatus 100 may be restricted if the apparatus is determined to be outside of a permitted geographic region.

The physical alignment validation subsystem 2020 may be configured to confirm that the apparatus 100 is properly aligned relative to a designated position of use, such as a barrier of access 202 (FIG. 10). Alignment validation may be performed using one or more sensor systems including the scanning sensors 210 and associated reference elements 200 described above. In certain embodiments, alignment validation may require detection of one or more tags 230 positioned at the designated position of use.

The authorization validation subsystem 2030 may be configured to verify that operation of the apparatus 100 is authorized. Authorization may be provided via manual input, entry of a code, interaction with a user interface, or via an external device 672 (FIG. 14), such as a mobile device, remote control, or wireless input system. In certain embodiments, authorization may be tied to a specific location, user, time-frame, or use condition.

The control system 170 may be configured such that satisfaction of one or more validation conditions is required prior to enabling operation of the apparatus 100. In certain embodiments, multiple validation conditions must be satisfied in combination, and failure of any required validation condition may prevent operation, including preventing transition of the platform 108 from the collapsed configuration 120 to the non-collapsed configuration 122.

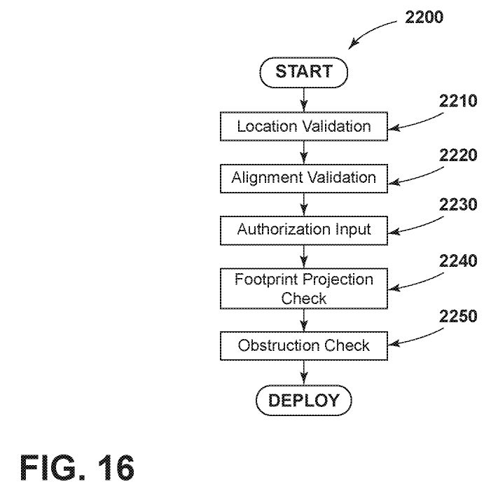

The control system 170 may further be configured to execute a deployment validation sequence 2200 prior to permitting deployment of the platform 108. As illustrated, for example, in FIG. 16, the deployment validation sequence may include:
(i) location validation 2210;
(ii) alignment validation 2220;
(iii) authorization validation 2230;
(iv) footprint projection verification 2240;
(v) obstruction detection 2250; and
(vi) confirmation of safe operating conditions. The determination of whether the operating criteria are satisfied may be based on comparison of measured or detected parameters to one or more predefined or dynamically determined thresholds

In certain embodiments, confirmation of safe operating conditions may include evaluation of one or more environmental, structural, operational, and system-level conditions associated with safe use of the apparatus 100. By way of example and not limitation, such safe operating conditions may include:
(i) detection of acceptable surface conditions, including levelness, stability, and sufficient load-bearing capacity of the support surface;
(ii) confirmation that environmental conditions are within acceptable thresholds, including precipitation (e.g., rain or snow), ice, moisture, wind conditions, temperature, or other weather-related factors that may impact traction, stability, or visibility;
(iii) verification that no excessive slope, incline, or uneven terrain is present within the footprint or travel path of the apparatus;
(iv) confirmation that the apparatus 100 is free from fault conditions, including actuator faults, sensor faults, or communication failures;
(v) confirmation that sufficient power is available to safely complete an intended operation, including verification that a battery level or power reserve exceeds a threshold required to complete deployment, lifting, lowering, or relocation operations , wherein the threshold may be dynamically determined based on an expected energy consumption associated with a selected operation, a current load on the platform 108, environmental conditions, or a predicted travel distance associated with relocation operations;
(vi) confirmation that the platform 108 is not overloaded and that a detected load is within an allowable threshold;
(vii) confirmation that required structural components, including ramps, rails, outriggers, or support structures, are properly positioned and secured; and
(viii) confirmation that no unsafe proximity conditions exist, including nearby obstructions, drop-offs, or hazards adjacent to the apparatus.

In certain embodiments, the term “operating criteria” may include one or more measurable or sensor-detected parameters used to determine whether operation of the apparatus 100 is permitted. Such parameters may include, for example, location data, alignment measurements, authorization status, obstruction detection, platform load, component position, battery level, environmental conditions, surface characteristics, or other system status indicators. In certain embodiments, the operating criteria may include threshold values, ranges, or conditions associated with one or more of the parameters, and may be evaluated individually or in combination to determine whether operation should be enabled, restricted, modified, or prevented.

In certain embodiments, one or more of the safe operating conditions may be determined using sensor inputs, stored thresholds, or dynamically determined criteria, and the control system 170 may prevent deployment, delay deployment, or modify operation of the apparatus 100 if one or more of the safe operating conditions are not satisfied.

In certain embodiments, the deployment validation sequence is executed in a predefined order, and the control system 170 may prevent progression to subsequent steps unless prior steps are satisfied. In other embodiments, the sequence may be dynamically adjusted based on real-time conditions, sensor inputs, or system status.

The control system 170 may further operate according to a state-based control model. The state-based control model may include a plurality of operational states including:
(i) a disabled state;
(ii) a validation state;
(iii) a ready state;
(iv) a deployment state;
(v) an operational state; and
(vi) a fault state. The validation operations may be performed sequentially, in parallel, asynchronously, or in a dynamically determined order, and are not limited to a fixed sequence unless explicitly required.

Transition between the operational states may be governed by the control system 170 based on evaluation of validation conditions, sensor inputs, and safety conditions. For example, the apparatus 100 may remain in the disabled state until required validation conditions are satisfied, may transition to the ready state upon successful validation, and may enter the deployment state upon receipt of an authorized command.

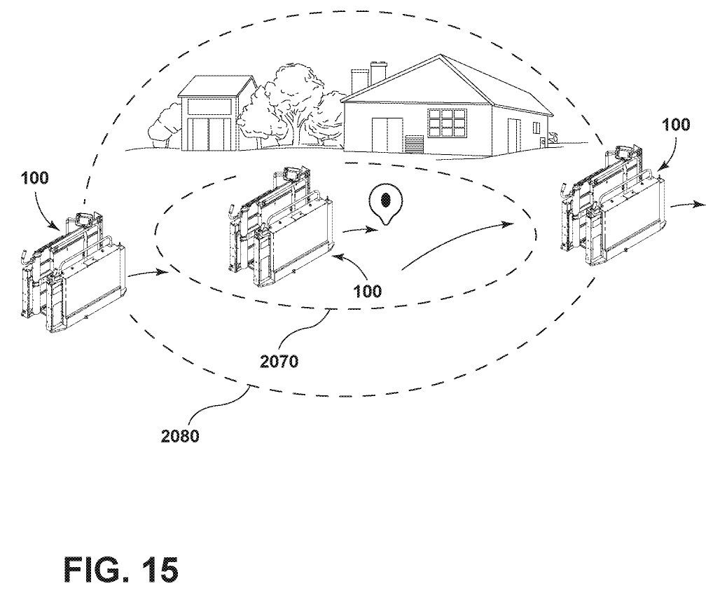

In certain embodiments, the repositionable lifting apparatus 100 may include autonomous or semi-autonomous relocation capabilities. As illustrated in FIG. 15, the apparatus 100 may be configured to move between positions within an environment based on one or more inputs including geographic data, sensor inputs, and/or user-defined instructions. In certain embodiments, the environment may be defined by one or more geofenced areas, including a first geofenced area 2070 and a second geofenced area 2080, wherein the second geofenced area 2080 defines a larger boundary encompassing the first geofenced area 2070 , and wherein movement of the apparatus 100 may further be controlled based on path planning algorithms, obstacle avoidance routines, or dynamically generated travel paths based on real-time sensor inputs.

Autonomous relocation may be performed using the mobility system described above, including the plurality of wheels and associated wheel motors. The control system 170 may control the wheel motors to move the apparatus 100 from a first location to a second location, such as between designated locations of use within the first geofenced area 2070. In certain embodiments, movement within the second geofenced area 2080 may be permitted for repositioning, staging, storage, or return-to-base operations, while movement within the first geofenced area 2070 may be more tightly controlled and associated with active deployment locations.

Prior to initiating relocation, the control system 170 may evaluate one or more validation conditions including location validation, alignment validation, and authorization validation. Location validation may include determining whether the apparatus 100 is positioned within the first geofenced area 2070 and/or the second geofenced area 2080. In certain embodiments, different validation requirements may be applied depending on which geofenced area the apparatus is located within. During relocation, the control system 170 may continuously monitor sensor inputs to detect obstacles, uneven terrain, or unsafe conditions.

In response to detection of an unsafe condition during relocation, the control system 170 may halt movement, modify a path of travel, or prevent further relocation. In certain embodiments, relocation may be constrained based on the defined geofenced areas such that the apparatus 100 is restricted from moving outside of the second geofenced area 2080, while deployment or lifting operations are restricted to positions within the first geofenced area 2070. In this manner, the second geofenced area 2080 may define a broader permissible movement region, while the first geofenced area 2070 may define a more limited operational region for performing lifting and positioning functions.

As discussed above, in certain embodiments, the repositionable lifting apparatus 100 may further include assisted or guided repositioning capabilities. The repositionable lifting apparatus 100 may be configured to automatically or semi-autonomously move between locations, including movement from a charging station or charging dock system to a selected place of use 204 associated with a barrier of access 202. Such movement may occur within the second geofenced area 2080 and may include movement into the first geofenced area 2070 for positioning and deployment.

The repositionable lifting apparatus 100 may utilize the mobility system described above, including the plurality of wheels and associated wheel motors, to perform relocation. The control system 170 may be configured to control one or more of the wheel motors and any associated steering mechanisms to drive and steer the apparatus 100. Movement of the apparatus 100 may be controlled automatically, semi-autonomously, or manually based on one or more signals generated by the controller 170.

In certain embodiments, the repositionable lifting apparatus 100 may include one or more sensors configured to detect obstacles, boundaries, or environmental conditions during relocation. Such sensors may be used to avoid obstacles in a movement path when relocating to a selected location of use. The control system 170 may continuously monitor sensor inputs during relocation and may adjust movement in real time to maintain safe operation, including modifying a direction of travel, reducing speed, or selecting an alternate path in response to detected obstacles or environmental changes.

In certain embodiments, the repositionable lifting apparatus 100 may be configured to follow a defined travel path between locations. The travel path may be defined using one or more pathway tags positioned on a support surface between the charging dock system and one or more selected places of use 204. The control system 170 may be configured to sequentially detect and follow the pathway tags to navigate between locations. In certain embodiments, geotagging, beacon-based positioning, or other sensor-based navigation techniques may be used in addition to or in place of pathway tags.

As discussed above, in certain embodiments, the repositionable lifting apparatus 100 may include an automatic alignment feature configured to align the apparatus with one or more reference elements or tags 230 at a designated place of use 204. Upon detection of a target tag, the control system 170 may control one or more wheel motors and/or steering mechanisms to position and orient the apparatus 100 relative to the tag. Such alignment may be required prior to enabling deployment of the platform 108 within the first geofenced area 2070.

In certain embodiments, the repositionable lifting apparatus 100 may be configured to return to the charging station or charging dock system upon completion of use, upon user input, or after a predetermined condition is satisfied. The predetermined condition may include expiration of a time period, completion of a task, detection of a low battery condition, or other operational criteria. In certain embodiments, the apparatus 100 may retrace a previously defined path of travel or may determine a return path dynamically based on sensor inputs and environmental conditions.

In certain embodiments, the control system 170 and/or validation subsystems may be configured to receive updates, modifications, or configuration changes from a remote system. Such remote interaction may include updating software, modifying validation parameters, adjusting operational thresholds, or addressing detected faults without requiring on-site intervention. The apparatus 100 may include a communication interface configured to enable secure communication with a remote computing system, server, or centralized management platform.

In certain embodiments, remotely provided instructions may be subject to the same validation and safety prioritization as locally generated inputs, such that remote commands do not override safety-related conditions. In other embodiments, authorized remote inputs may be permitted to modify or reset certain system states, including in response to detected sensor faults or operational errors.

In certain embodiments, an initial setup procedure may be performed to define one or more travel paths between the charging dock system and one or more places of use 204. During the setup procedure, a user or technician may manually guide the repositionable lifting apparatus 100 along a desired path of travel, and the control system 170 may record the path for subsequent automatic relocation. In other embodiments, travel paths may be generated dynamically based on environmental mapping or sensor data.

In certain embodiments, the repositionable lifting apparatus 100 may be configured to relocate while supporting a user or mobility device on the platform 108. In such embodiments, relocation may be subject to additional validation conditions and safety constraints, including speed limitations, enhanced obstacle detection, and confirmation that the platform 108 is in a suitable configuration for transport. The apparatus 100 may be configured to move between designated places of use identified by name, identifier, or location data.

The control system 170 may include a decision engine 2100 (FIG. 14) configured to evaluate inputs from a plurality of subsystems and determine whether operation of the apparatus 100 is permitted. The decision engine 2100 being implemented as software, firmware, hardware, or a combination thereof executed by the control system 170. The decision engine 2100 may evaluate inputs using rule-based logic, conditional logic, or adaptive control logic , and in certain embodiments may further include predictive logic, heuristic evaluation, or machine-learning-based models trained on prior operational data to improve decision accuracy over time , and in certain embodiments may assign weighted values to inputs received from the plurality of subsystems and determine whether operation of the apparatus 100 is permitted based on a composite evaluation of such weighted inputs, wherein the composite evaluation may include prioritization of safety-related inputs over user inputs and operational requests. In certain embodiments, the control system 170 may selectively enable, disable, restrict, modify, or prevent operation of one or more components of the apparatus 100 based on evaluation of the operating criteria.

In certain embodiments, functionality described herein as decision logic, decision-making, or operation of the decision engine 2100 may be implemented by one or more processors executing instructions, control circuitry, or distributed computing resources. Such functionality may be implemented locally within the apparatus 100, partially or entirely within an external device such as a mobile application, or via a remote or cloud-based computing system. Accordingly, the present disclosure is not limited to any particular location, architecture, or implementation of the decision logic, and may include distributed or off-device implementations.

Inputs to the decision engine 2100 may include:
(i) validation inputs from the validation system 2000;
(ii) sensor inputs from the various sensor systems;
(iii) safety inputs including non-contact detection systems such as the light curtain system 710;
(iv) power system inputs including battery status;
(v) structural configuration inputs including limit switches; and
(vi) user inputs received via the controller 170 or external device 672, wherein the decision engine 2100 may further be configured to resolve conflicts between inputs by applying a hierarchical prioritization scheme and/or predefined decision rules , including real-time arbitration between simultaneously received inputs, such that safety-related inputs override conflicting inputs associated with user commands or operational requests , and wherein time-sensitive inputs may be prioritized based on immediacy of risk or operational impact. In certain embodiments, evaluation of operating criteria and control of the apparatus 100 may be performed locally, remotely, or in a distributed manner, including via a mobile application, remote server, or cloud-based system.

In certain embodiments, the one or more sensor systems, including the light curtain system, may be configured to detect obstructions that arise during operation of the apparatus 100, including during lifting, lowering, or repositioning of the platform 108. For example, an object entering a detection field after initiation of a movement operation may trigger a safety response by the control system 170. In response, the control system 170 may halt, restrict, reverse, or otherwise modify the movement of the platform 108 until the obstruction condition is cleared. In this manner, the apparatus 100 is configured to provide continuous, real-time obstruction monitoring throughout operation, rather than solely prior to deployment or initiation of movement.

The decision engine 2100 may evaluate the inputs according to a hierarchical prioritization structure, wherein safety-related inputs override user inputs, and validation conditions must be satisfied prior to enabling operation. Based on such evaluation, the control system 170 may selectively:
(i) enable operation;
(ii) restrict operation;
(iii) modify operation; or
(iv) prevent operation, wherein execution of a user command is treated as a request for operation rather than a direct control instruction, and is conditionally executed only upon approval by the decision engine 2100 based on satisfaction of one or more validation, safety, and operational criteria as determined at the time of execution.

In certain embodiments, the control system 170 is configured such that operation of the apparatus 100 is governed by system-level control logic rather than direct execution of user commands. In other words, user inputs may be treated as requests for operation, which are only executed upon approval by the decision engine 2100, and may be delayed, modified, or rejected if one or more higher-priority conditions are not satisfied , and wherein the decision engine 2100 may further interrupt or override an already-initiated operation in response to subsequently detected safety conditions or higher-priority inputs.

In certain embodiments, the decision engine 2100 may be configured to dynamically adjust one or more operational thresholds based on real-time inputs, historical usage data, or environmental conditions. For example, thresholds associated with obstruction detection, power sufficiency, allowable movement speeds, or deployment conditions may be modified based on detected terrain conditions, load characteristics, battery status, or prior operational data. The decision engine 2100 may further utilize predictive logic to determine whether a requested operation can be safely completed prior to initiation of the operation , including simulation or estimation of future states of the apparatus 100 based on current inputs, expected actuator behavior, and environmental conditions.

In certain embodiments, the decision engine 2100 may implement a state-aware evaluation process, wherein the determination of whether to permit or restrict an operation is dependent upon a current operational state of the apparatus 100, including one or more of the disabled state, validation state, ready state, deployment state, operational state, or fault state. The decision engine 2100 may apply different decision criteria or thresholds depending on the current operational state , including dynamically modifying permissible actions, thresholds, or response behaviors based on the current state of the apparatus 100.

The repositionable lifting apparatus 100 may further include an integrated safety system comprising a plurality of sensing and control subsystems configured to detect unsafe conditions and initiate corrective actions. The safety system may include one or more of:
(i) impact sensors including platform, lateral, lift, ramp, rail, and outrigger impact sensors;
(ii) non-contact detection systems including the light curtain system 710 (FIG. 7);
(iii) occupancy sensors 652;
(iv) leveling sensors 654A and leveling actuators 654B;
(v) ground pressure sensors 662;
(vi) accelerometers or tilt sensors 664; and
(vii) unfolding clearance sensors 640C.

The safety system may be configured such that detection of an unsafe condition by any one or more of the sensing subsystems results in a safety response initiated by the control system 170. The safety response may include halting motion, preventing initiation of motion, reversing motion, limiting movement range, or initiating controlled descent of the platform 108.

In certain embodiments, the repositionable lifting apparatus 100 may include a non-contact detection system configured to detect the presence of objects or persons within a defined region of the apparatus without requiring physical contact. The non-contact detection system may include a light curtain system 710, as illustrated in FIG. 7, positioned along one or more portions of the apparatus, including an underside region of the platform 108.

The light curtain system 710 may define a dynamic safety boundary surrounding at least a portion of the apparatus 100. In certain embodiments, the light curtain system 710 is configured to detect the presence of an object within a defined detection field and to communicate with the control system 170 to halt, prevent, or modify movement of the apparatus 100. The non-contact detection system may include one or more sensing technologies, including optical, infrared, laser, ultrasonic, LiDAR, electromagnetic, or other sensing technologies configured to detect objects without physical contact.

In certain embodiments, the light curtain system 710 operates in conjunction with the control system 170 and one or more actuators, including the lifting mechanism 104, to prevent unsafe interactions such as crushing, trapping, or interference with objects or persons. Movement of the apparatus 100 may be restricted until a detected obstruction is removed, and the control system 170 may prevent continued lowering or raising of the platform 108 until safe conditions are restored.

As illustrated in FIG. 7, the light curtain system 710 may include one or more emitter arrays 712 and one or more receiver arrays 714 configured to define a detection field 716 extending across a region of interest. Interruption of the detection field 716 may define an interruption condition. Interruption of the detection field 716 may be caused by an object 718 moving under the platform 108 through the detection field 716, as illustrated in FIG. 10.

Upon detection of an interruption condition, the control system 170 may initiate a safety response. The safety response may include one or more of:
halting motion, preventing initiation of motion, reversing motion, limiting movement range, or otherwise modifying operation of the apparatus 100 to mitigate risk.

In certain embodiments, the light curtain system 710 may operate independently or in combination with other sensing systems described herein, including impact sensors, occupancy sensors, and clearance sensors, to provide redundant or complementary safety detection capabilities.

In certain embodiments, the repositionable lifting apparatus 100 may include a power system configured to provide electrical power to one or more components of the apparatus, including the lifting mechanism 104, control system 170, sensor systems, and mobility system. The power system may include a primary power source, a backup power source, and an external power interface configured to receive power from an external source, such as a standard electrical outlet.

The control system 170 may be configured to continuously monitor one or more power conditions associated with the power system, including voltage levels, battery status, charge levels, and power availability. In certain embodiments, the control system 170 may determine whether sufficient power is available to safely initiate and complete an intended operation of the apparatus 100.

Upon detection of a primary power failure or insufficient primary power condition, the control system 170 may automatically transition operation to the backup power source. Such transition may occur without interruption of one or more critical functions of the apparatus 100, including maintenance of platform position, controlled movement, or safety monitoring.

In certain embodiments, if both the primary power source and the backup power source are unavailable or insufficient, the control system 170 may initiate a fail-safe response. The fail-safe response may include controlled descent of the platform 108 to a lower or safe position.

The controlled descent of the platform 108 may be performed using a manual lowering system, an electronically controlled descent mechanism, or a combination thereof. The manual lowering system may be configured to allow an operator to safely lower the platform 108 in the event of power failure, system malfunction, or emergency conditions.

In certain embodiments, the control system 170 may restrict further operation of the apparatus 100 until acceptable power conditions are restored. Such restrictions may include preventing lifting operations, deployment of the platform 108, or relocation of the apparatus 100 until sufficient power is available.

The power system and non-contact detection system described herein may operate in conjunction with the control system 170 and decision engine 2100 such that detection of unsafe conditions, including obstruction detection or insufficient power conditions, results in automatic modification or restriction of operation. In certain embodiments, safety-related inputs, including those generated by the light curtain system 710 and power monitoring systems, may be prioritized over user inputs.

In certain embodiments, the control system 170 may define one or more failure modes, wherein the apparatus 100 is configured to automatically initiate one or more predefined responses without requiring user input. Such responses may include halting operation, initiating controlled descent, disabling certain functions, or transitioning the apparatus 100 to a fault state until the condition is resolved.

In certain embodiments, the repositionable lifting apparatus 100 may include a plurality of sensing systems associated with various movable components of the apparatus 100. The sensing systems may be configured to monitor position, detect obstructions, and provide feedback to the control system 170 for enabling controlled and safe operation of the apparatus 100.

In certain embodiments, the lifting mechanism 104 and/or platform 108 may include a platform position sensor 640A configured to monitor an angular position of the platform 108 relative to the at least one lifting column 102. The platform position sensor 640A may communicate position data to the control system 170 to determine whether the platform 108 is in the collapsed configuration 120 or the non-collapsed configuration 122.

The lifting mechanism 104 and/or platform 108 may further include a platform impact sensor 640B configured to detect contact between the platform 108 and an external object. Upon detection of an obstruction, the platform impact sensor 640B may communicate with the control system 170 to halt deployment and optionally return the platform 108 to the collapsed configuration 120.

In certain embodiments, the platform impact sensor 640B or other sensing structures positioned along an underside of the platform 108 may include extended detection elements, such as bristles or flexible contact members, configured to increase a sensing range. Contact with such elements during movement may result in immediate cessation of motion.

In certain embodiments, the lateral actuator 126 may include a lateral position sensor 642A configured to monitor lateral positioning of the platform 108 relative to the lifting column 102. The lateral position sensor 642A may provide positional feedback to the control system 170 to control movement between defined lateral positions.

The lateral actuator 126 may further include a lateral impact sensor 642B configured to detect contact between the platform 108 and an external object during lateral movement. Upon detection, the control system 170 may cease lateral movement and return the platform 108 to a neutral or predefined position.

In certain embodiments, the lifting mechanism 104 may include a lift position sensor 644A configured to monitor vertical position and/or height of the platform 108 relative to the support surface 302. The lift position sensor 644A may provide input to the control system 170 to enable controlled vertical positioning based on user input or automated control sequences.

The lifting mechanism 104 may further include a lift impact sensor 644B configured to detect contact between the platform 108 and an external element during vertical movement. Upon detection, the control system 170 may halt vertical motion and optionally reverse movement to relieve contact.

In certain embodiments, the ramp actuator 136 may include a ramp position sensor 646A configured to monitor a position of the ramp 110 relative to the platform 108. The ramp position sensor 646A may enable the control system 170 to control movement of the ramp 110 between multiple positions including stored, barrier, and access configurations.

The ramp actuator 136 may further include a ramp impact sensor 646B configured to detect contact between the ramp 110 and an external object. Upon detection, the control system 170 may cease movement and reposition the ramp 110 to a safe orientation.

In certain embodiments, the rail actuator associated with the collapsible railing 630 may include a rail position sensor 648A configured to monitor positioning of the railing between stored and erected positions.

The rail actuator may further include a rail impact sensor 648B configured to detect contact between the railing 630 and an external object. Upon detection, the control system 170 may halt motion and reposition the railing to reduce risk of interference or injury.

In certain embodiments, the outrigger actuator 188 may include an outrigger position sensor 650A configured to monitor positioning of the outriggers 180, 182 between folded and deployed positions.

The outrigger actuator 188 may further include an outrigger impact sensor 650B configured to detect contact with an external object during deployment or retraction. The control system 170 may halt motion and adjust positioning in response to detected interference.

In certain embodiments, the repositionable lifting apparatus 100 may include an unfolding clearance sensor 640C configured to detect obstructions within a deployment pathway of the platform 108. The unfolding clearance sensor 640C may be integrated with the footprint projection system 300.

The control system 170 may prevent deployment of the platform 108 unless the deployment region is free from obstructions. In certain embodiments, an alert may be generated if an obstruction is detected within the deployment pathway.

In certain embodiments, the repositionable lifting apparatus 100 may include an occupancy sensor 652 configured to detect whether a user or mobility device is positioned on the platform 108. The control system 170 may restrict operation unless occupancy conditions are satisfied.

The apparatus 100 may further include one or more ground pressure sensors 662 and/or tilt detection sensors such as accelerometers or gyroscopes configured to detect unsafe tilt or instability conditions. The control system 170 may restrict lifting or initiate corrective actions based on such inputs.

In certain embodiments, the control system 170 may continuously evaluate inputs from a plurality of sensing systems including position sensors and impact sensors associated with the platform, lifting mechanism, ramp, railing, and outriggers.

Upon detection of an unsafe condition, the control system 170 may halt, restrict, or reverse operation of one or more components of the apparatus 100.

In certain embodiments, the control system 170 may be configured to execute predefined responses associated with specific sensor inputs. For example:
detection by a platform impact sensor may halt deployment, detection by a lateral impact sensor may stop lateral movement, detection by a lift impact sensor may halt vertical motion, detection by a ramp impact sensor may stop ramp deployment.

In certain embodiments, detection of an unsafe tilt condition may prevent further lifting and may initiate stabilization or controlled descent of the platform 108.

In certain embodiments, detection that the platform 108 is unoccupied may result in disabling or restricting lifting functionality.

In certain embodiments, multiple sensor inputs may be evaluated simultaneously, and the control system 170 may determine a response based on combined conditions, including prioritization of safety-related inputs over operational commands.

In certain embodiments, the repositionable lifting apparatus 100 may include a leveling system comprising one or more leveling sensors 654A and leveling actuators 654B configured to maintain vertical and horizontal alignment of the apparatus 100 relative to the support surface.

The control system 170 may control the leveling actuators 654B based on inputs from the leveling sensors 654A to compensate for uneven terrain and maintain stable positioning during operation of the apparatus 100.

In certain optional embodiments, the repositionable lifting apparatus 100 may include a locking feature configured to selectively restrict operation of one or more functions of the apparatus 100. The locking feature may include a key lock, electronic lock, access-controlled interface, or other locking mechanism operatively coupled to the control system 170.

The locking feature may be configured to cause the apparatus 100 to enter a ground seating mode in which one or more operational functions are disabled. Such disabled functions may include, for example, folding of the platform 108, operation of the mobility system, and/or relocation of the apparatus 100 along the support surface 302, including disabling actuation of one or more wheel motors, restricting autonomous or semi-autonomous relocation functions, and/or physically or electronically locking one or more actuators to prevent movement of structural components.

In certain embodiments, the ground seating mode may be particularly advantageous in controlled environments such as live events, concerts, or other crowded venues where movement of the apparatus 100 may be unnecessary or present safety concerns. In such configurations, the apparatus 100 may remain stationary while continuing to provide lifting functionality.

In certain optional embodiments, the repositionable lifting apparatus 100 may further include at least one additional lifting mechanism (not shown). The additional lifting mechanism may be positioned between the platform support assembly 106 and the platform 108.

The additional lifting mechanism may be configured to provide supplemental vertical movement of the platform 108, thereby enabling the platform 108 to reach elevations beyond those achievable using the primary lifting mechanism 104 alone.

In certain embodiments, the additional lifting mechanism may permit vertical adjustment of the platform 108 without requiring corresponding extension of the lifting column 102. This configuration may allow for finer positioning control, increased height range, or improved adaptability to various barriers of access.

In certain optional embodiments, the repositionable lifting apparatus 100 may be configured to detect resistance encountered during operation of one or more actuators. Resistance may be identified when an actuator senses a force exceeding a predetermined operational threshold, and upon such detection the control system 170 may automatically halt the associated movement without requiring user input, override a user-issued command, and/or initiate a reversal of the movement to reduce applied force.

Upon detection of resistance, the control system 170 may pause the associated movement for a predetermined period of time and may subsequently attempt to resume the movement. The pause duration and retry behavior may be predefined or dynamically determined.

If the resistance condition persists, the control system 170 may cause the apparatus 100 to return to a prior position, such as a collapsed, folded, or storage configuration. In certain embodiments, the control system 170 may require user intervention prior to reinitiating operation.

The control system 170 may further be configured to generate an alert or notification indicating that an obstruction or resistance condition has been detected. The alert may be communicated via a user interface, control panel, mobile device, or other communication system.

In certain embodiments, the repositionable lifting apparatus 100 may include an error detection and reporting system configured to identify malfunctions or abnormal operating conditions.

The control system 170 may generate an error code corresponding to a detected issue associated with a component or subsystem of the apparatus 100. The error code may be displayed via a control interface, such as a user interface panel or display screen.

In certain embodiments, error codes may be associated with severity indicators, such as color-coded alerts. For example, a green indicator may represent a low-priority condition, a yellow indicator may represent a moderate condition requiring attention, and a red indicator may represent a high-priority condition requiring immediate action.

The error detection system may be integrated with the control system 170 such that certain operations of the apparatus 100 are restricted or disabled based on the type or severity of the detected condition.

In certain embodiments, the repositionable lifting apparatus 100 may further include a charging dock system 500 configured to store, protect, and recharge the apparatus 100 when not in use. The charging dock system 500 may also be referred to herein as a charging system 500 or charging station 500. As illustrated, for example, in FIG. 5, the charging dock system 500 may include a housing 502 configured to receive the repositionable lifting apparatus 100 when the platform 108 is positioned in the collapsed configuration 120. In other optional embodiments, the charging dock station 500 may not include a house, but may instead just comprise a charging dock configured to receive the repositionable lifting apparatus 100. In further optional embodiments, the repositionable lifting apparatus 100 may be plugged into a power source for charging using a charging port 600.

The housing 502 may include at least one door 504 positioned along an end or side of the housing 502. The at least one door 504 may include a first door and/or a second door and may be configured to provide access to the repositionable lifting apparatus 100 from a rear or lateral side. In certain embodiments, the door configuration may facilitate entry and exit of the apparatus 100 during docking and undocking operations.

In certain embodiments, the charging dock system 500 may include an alignment interface configured to guide positioning of the repositionable lifting apparatus 100 within the housing 502. The alignment interface may include mechanical guides, tapered surfaces, rails, visual indicators, or sensor-assisted alignment systems configured to assist proper positioning of the apparatus 100 relative to the charging dock system 500.

The charging dock system 500 may further include an electrical interface configured to provide charging contact with the repositionable lifting apparatus 100. The electrical interface may include conductive contacts, inductive charging elements, or other power transfer mechanisms configured to supply electrical power to the battery bank 160 of the apparatus 100.

In certain embodiments, the at least one door 504 may be configured to open and close manually and/or automatically. One or more door actuators may be provided to enable automated opening and closing of the at least one door 504. The charging dock system 500 may further include a user-actuatable control, such as a button positioned on the exterior of the housing 502, configured to unlock, open, or close the at least one door 504.

In certain embodiments, multiple charging dock systems 500 may be positioned adjacent to one another. In such configurations, actuation of a control input may be configured to open a single door or may be configured to open multiple doors simultaneously, such as through a master control configured to control a plurality of charging dock systems 500.

The charging dock system 500 may be configured to protect the repositionable lifting apparatus 100 from environmental conditions including precipitation, debris, and temperature exposure. In addition, the charging dock system 500 may provide a protective enclosure configured to deter vandalism, tampering, or theft of the apparatus 100.

In certain embodiments, the housing 502 of the charging dock system 500 may be secured to the support surface 302. For example, the housing 502 may be bolted, anchored, or otherwise fastened to the support surface 302 to prevent unauthorized removal of the housing 502 and access to the repositionable lifting apparatus 100.

In certain embodiments, the battery bank 160 of the repositionable lifting apparatus 100 may include a plurality of batteries, such as at least a first battery and a second battery. During operation, one of the batteries may function as a primary power source while the other functions as a backup power source.

In certain embodiments, the control system 170 may be configured to alternate usage of the plurality of batteries between successive operations. For example, a battery used as the primary power source during a first operation cycle may be designated as a backup battery during a subsequent operation cycle. Such alternating use may improve battery longevity and overall system reliability.

Charging of the battery bank 160 may occur when the repositionable lifting apparatus 100 is positioned within the charging dock system 500 and electrically coupled via the electrical interface. The control system 170 may monitor charging status and may integrate charging conditions into system-level decision-making, including restricting operation when insufficient charge is available.

In certain embodiments, the repositionable lifting apparatus 100 may include a braking system associated with the plurality of wheels. The braking system may include a brake lever 610 coupled to at least one handle 150 of the apparatus 100.

The brake lever 610 may be configured such that actuation of the brake lever releases one or more brakes associated with the wheels, and release of the brake lever causes the brakes to engage. In certain embodiments, the braking system may be integrated with one or more wheel motors.

This configuration may provide a fail-safe braking mechanism such that if a user loses control of the apparatus 100 while moving along a support surface, including on an incline or ramp, the apparatus 100 may automatically stop upon release of the brake lever.

In certain embodiments, individual brake controls may be provided for one or more wheels, allowing selective locking of front wheels, rear wheels, or all wheels. In certain configurations, wheel positioning may be required prior to engagement of a locking position.

In certain embodiments, the repositionable lifting apparatus 100 may further include a directional wheel lock mechanism configured to restrict rotational movement of one or more wheels in a selected direction. The directional wheel lock mechanism may be actuated in a manner similar to the brake lever 610.

In certain embodiments, the platform 108 may include adjustable dimensions, including adjustable width and/or length. Such adjustability may allow the platform 108 to accommodate mobility devices and users of varying sizes, wherein adjustment of the platform dimensions may be performed manually or via one or more actuators controlled by the control system 170, and may occur automatically based on detected characteristics of the mobility device or user.

In certain embodiments, one or more sensors may be configured to detect a size or footprint of a mobility device and/or user positioned on the platform 108. The control system 170 may adjust dimensions of the platform 108 dynamically based on such detected characteristics.

Dynamic adjustment of the platform 108 may allow the apparatus 100 to minimize an operational footprint while maintaining sufficient support and safety for the user.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

Although embodiments of the present invention have been described in detail, it will be understood by those skilled in the art that various modifications can be made therein without departing from the spirit and scope of the invention as set forth in the appended claims.

A controller, computing device, or computer, such as described herein, includes at least one or more processors or processing units and a system memory. The controller may also include at least some form of computer readable media. By way of example and not limitation, computer readable media may include computer storage media and communication media. Computer readable storage media may include volatile and nonvolatile, removable and non-removable media implemented in any method or technology that enables storage of information, such as computer readable instructions, data structures, program modules, or other data. Communication media may embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

This written description uses examples to disclose the invention and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

It will be understood that the particular embodiments described herein are shown by way of illustration and not as limitations of the invention. The principal features of this invention may be employed in various embodiments without departing from the scope of the invention. Those of ordinary skill in the art will recognize numerous equivalents to the specific procedures described herein. Such equivalents are considered to be within the scope of this invention and are covered by the claims.

All of the compositions and/or methods disclosed and claimed herein may be made and/or executed without undue experimentation in light of the present disclosure. While the compositions and methods of this invention have been described in terms of the embodiments included herein, it will be apparent to those of ordinary skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The previous detailed description has been provided for the purposes of illustration and description. Thus, although there have been described particular embodiments of a new and useful invention, it is not intended that such references be construed as limitations upon the scope of this disclosure except as set forth in the following claims.

What is claimed is:

1. A system for controlling operation of a repositionable lifting apparatus, the system comprising:
a platform configured to support a user or mobility device;
a lifting assembly coupled to the platform and operable to vertically move the platform relative to a support surface;
a mobility system configured to reposition the lifting assembly relative to the support surface;
one or more sensor systems configured to generate sensor data associated with at least one of position, alignment, environmental conditions, obstructions, load, or system status; and
a control system comprising one or more processors and memory storing instructions that, when executed, cause the control system to:
receive the sensor data and validation data from one or more subsystems;
determine whether one or more operating criteria are satisfied based on the received data; and
selectively enable, restrict, modify, or prevent operation of at least one of the lifting assembly, platform, or mobility system based on the determination.

2. The system of claim 1, wherein the operating criteria comprise at least one measurable or sensor-detected parameter selected from: location, alignment, authorization, obstruction presence, surface condition, platform load, component position, battery level, or environmental condition.

3. The system of claim 1, wherein the instructions further cause the control system to prioritize safety-related inputs over user inputs when determining whether to enable or restrict operation.

4. The system of claim 1, wherein the instructions further cause the control system to initiate a fail-safe response upon detection of a fault condition.

5. The system of claim 1, wherein determining whether the operating criteria are satisfied includes evaluating a plurality of criteria in combination.

6. The system of claim 1, wherein determining whether the operating criteria are satisfied includes evaluating two or more criteria selected from location, alignment, authorization, obstruction detection, and operating conditions.

7. The system of claim 1, wherein evaluation of the operating criteria is performed sequentially, in parallel, asynchronously, or in a dynamically adjusted order.

8. The system of claim 1, wherein the validation data includes geographic data, and wherein operation is restricted when the apparatus is outside of a permitted geographic region.

9. The system of claim 1, wherein the validation data includes alignment data generated based on detection of one or more reference elements.

10. The system of claim 1, wherein the validation data includes authorization data received from an external device.

11. The system of claim 1, wherein the control system is further configured to treat a user command as a request for operation and to conditionally execute the request only when the operating criteria are satisfied.

12. The system of claim 1, wherein the one or more sensor systems include at least one of optical, infrared, laser, ultrasonic, LiDAR, or electromagnetic sensors.

13. A repositionable lifting apparatus comprising:
a platform movable between a collapsed configuration and a deployed configuration, the platform configured to support a user or mobility device when in the deployed configuration;
a lifting mechanism operatively coupled to the platform and configured to vertically move the platform relative to a support surface;
a mobility system configured to reposition the apparatus relative to the support surface;
one or more sensors configured to detect at least one of position, alignment, environmental conditions, obstructions, load, or system status; and
a control system comprising one or more processors and memory storing instructions that, when executed, cause the control system to:
receive inputs from the one or more sensors and at least one validation subsystem;
determine whether one or more operating criteria are satisfied; and
selectively enable, restrict, modify, or prevent at least one of deployment, lifting, lowering, or relocation of the apparatus based on the determination.

14. The apparatus of claim 13, wherein the operating criteria include confirmation of location, alignment, authorization, and safe operating conditions.

15. The apparatus of claim 13, wherein the control system evaluates a plurality of operating criteria and prevents operation when any required criterion is not satisfied.

16. The apparatus of claim 13, wherein evaluation of the operating criteria is performed sequentially, in parallel, asynchronously, or in a dynamically adjusted order.

17. The apparatus of claim 13, further comprising a projection system configured to project a footprint corresponding to a deployment area of the platform.

18. The apparatus of claim 17, wherein the control system prevents deployment of the platform when the projected deployment area is obstructed.

19. A method of operating a repositionable lifting apparatus, comprising:
receiving sensor data and validation data from one or more subsystems including at least one of a location-based validation system, an alignment validation system, or an authorization system;
evaluating the received data using a control system;
determining whether one or more operating criteria are satisfied based on the received data; and
controlling operation of the apparatus by:
enabling at least one function when the operating criteria are satisfied; and
restricting, modifying, or preventing at least one function when the operating criteria are not satisfied.

20. The method of claim 19, further comprising selectively enabling or disabling individual operational functions based on the evaluated operating criteria, wherein the evaluation includes prioritizing safety-related inputs over user inputs.
